(19) United States
(12) Patent Application Publication
(10) Pub. No.: US 2014/0264983 A1
(43) Pub. Date: Sep. 18, 2014

(54) Systems And Methods For Light Lens Hot Stamping

(71) Applicant: Danny Steven Cape, Hawkinsville, GA (US)

(72) Inventor: Danny Steven Cape, Hawkinsville, GA (US)

(21) Appl. No.: 14/204,824

(22) Filed: Mar. 11, 2014

Related U.S. Application Data
(60) Provisional application No. 61/777,289, filed on Mar. 12, 2013.

(51) Int. Cl. G02B 1/04

(52) U.S. Cl. CPC G02B 1/041
USPC 264/2.6; 264/1.1; 425/363

(57) ABSTRACT

The present disclosure provides systems and methods for fabricating a patterned lens through hot stamping techniques. In certain example embodiments, a lens material is placed in a heat press. The heat press includes at least one shim having a patterned surface. The shim is pressed onto the lens material with the patterned surface contacting the lens material. The heat press heats the lens material to malleability and the pattern of the shim is pressed into the lens material. The lens material is then cooled and a patterned lens is fabricated.

### RELATED APPLICATION

This application claims priority under 35 U.S.C. §119 to U.S. Provisional Patent Application No. 61/777,289, titled “Systems and Methods for Light Lens Hot Stamping,” filed on Mar. 12, 2013, the complete disclosure of which is hereby fully incorporated herein by reference.

### TECHNICAL FIELD

Embodiments of the invention relate generally to lighting solutions, and more particularly to systems and methods for fabricating light lenses for edge-lit lighting solutions through hot stamping.

### BACKGROUND

Lenses for edge-lit lighting solutions are generally fabricated to have a patterned surface for distributing light in a desired and effective manner. Traditionally, such lenses are fabricated in an injection molding process. During the injection molding process, raw acrylic in its solid form is melted into its liquid form and then injected into a mold or die, which includes a pattern to be formed in the lens. In order to do this, all of the acrylic must be melted before it is injected into the mold or die. The acrylic must then be cooled and solidified before being removed from the mold or die. Thus, the process is rather costly and time consuming due to the energy and time required to heat the raw acrylic as well as the subsequent steps of solidifying and removing the patterned lens.

### SUMMARY

According to one aspect of the present disclosure, a method of fabricating a light lens includes receiving a lens material into a heat press. The heat press includes a first press bed and a first heat plate coupled to the first press bed, the first heat plate comprising a temperature control system. The heat press further includes a first shim comprising a first side and a second side, the first side coupled to the first heat plate opposite the first press bed and the second side having a first pattern, and wherein heat is conductive between the first heat plate and the first shim. The heat press further includes a second press bed aligned with respect to the first shim, wherein the lens material is disposed between the second press bed and the first shim. The method also includes applying pressure to the lens material while disposed between the first shim and the second press bed. The method further includes heating the lens material via heat provided to the first shim from the temperature control system in the first heat plate, and transferring a pattern corresponding to the first pattern of the first shim to the lens material, forming a patterned lens.

According to another aspect of the present disclosure, a system for hot stamping a light lens includes a first press bed and a first heat plate coupled to the first press bed, in which the first heat plate comprises a first temperature control system. The system also includes a first shim comprising a first side and a second side, the first side coupled to the first heat plate opposite the first press bed and the second side having a first lens pattern, and wherein heat is conductive between the first heat plate and the first shim. The system further includes a second press bed aligned with respect to the first shim, wherein a lens material is to be placed between the second press bed and the first shim.

According to another aspect of the present disclosure, a method of fabricating a patterned lens includes receiving a lens material into a heat press, the heat press comprising a patterned shim. The method further comprising applying pressure to the lens material with the heat press, in which the patterned shim is in contact with and pressed against the lens material. The method further includes heating the lens material with the heat press, and transferring a pattern corresponding to the patterned shim to the lens material, thereby forming a patterned lens.

### BRIEF DESCRIPTION OF THE FIGURES

Reference will now be made to the accompanying drawings, which are not necessarily drawn to scale, and wherein:

FIG. 1 is a perspective view of a hot stamping press and lens material in a first step of a light lens hot stamping process in accordance with an example embodiment;

FIG. 2 is a perspective view of the hot stamping press and lens material of FIG. 1 in a second step of a light lens hot stamping process in accordance with an example embodiment;

FIG. 3 is a perspective view of the hot stamping press and lens material of FIG. 1 in a third step of a light lens hot stamping process in accordance with an example embodiment; and

FIG. 4 is a perspective view of the hot stamping press and lens in a fourth step of a light lens hot stamping process in accordance with an example embodiment.

The drawings illustrate only example embodiments of the invention and are therefore not to be considered limiting of its scope, as the invention may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

### DETAILED DESCRIPTION OF EXAMPLE EMBODIMENTS

Example embodiments disclosed herein are directed to systems and methods for forming a light lens or a light emitting panel (LEP) of a luminaire or light fixture in which the light lens includes one or more patterned surfaces for directing light. Example embodiments disclosed herein are also directed to systems and methods of forming such patterned surfaces on light lenses through a hot stamping process. The example embodiments provide the ability to make such patterned light lenses with increased efficiency and cost-effectiveness compared to traditional injection molding processes. The example embodiments refer to using an acrylic material as the light lens. However, in other example embodiments, the light lens is fabricated from other appropriate material known in the art, such as but not limited to, a polycarbonate material.

Referring to the figures, FIGS. 1-4 provide perspective views of a press 100 in various positions in accordance with example embodiments of the present invention. Specifically, FIG. 1 provides a perspective view of the press 100 in an open position and a lens material 140 to be disposed in the press 100. FIG. 2 provides a perspective view of the press 100 in the open position with the lens material 140 placed in the press 100. FIG. 3 provides a perspective view of the press 100 in a closed position with the lens material 140 disposed in the press. FIG. 4 provides a perspective view of the press 100 in the open position in which the lens material 140 is removed from the press 100 and has been formed into a patterned lens 400.

Referring to FIGS. 1-4, the press 100 includes an upper press bed 102, a lower press bed 104, an upper die plate 120, a lower die plate 106, an upper heat plate 122, a lower heat plate 108, an upper shim 130, and a lower shim 110. In certain example embodiments, the upper press bed 102 includes a first side 103a and a second side 103b, in which the first side 103a faces away from the lower press bed 104 and the second side 103b faces towards the lower press bed 104. Likewise, the lower press bed 104 includes a first side 105a and a second side 105b, in which the first side 105a faces away from the upper press bed 102 and the second side 105b faces towards the upper press bed 102.

In an example embodiment, the upper die plate 120 is affixed onto the second side 103b of the upper press bed 102. The upper heat plate 122 is affixed onto the upper die plate 120 opposite the upper press bed 102, and the upper shim 130 is affixed onto the upper heat plate 122 opposite the upper die plate 120. Likewise, in an example embodiment, the lower die plate 106 is affixed onto the second side 105b of the lower press bed 104. The lower heat plate 108 is affixed onto the lower die plate 106 opposite the lower press bed 104, and the lower shim 110 is affixed onto the lower heat plate 108 opposite the lower die plate 106.

In an example embodiment, the upper press bed 102 and the lower press bed 104 are positioned relative to each other such that the upper shim 130 is aligned with and facing the lower shim 110 in the open position, as illustrated in FIG. 1. The press beds 102, 104 are parts of a press system in which the upper press bed 102 is configured to travel in a defined path and distance towards to second press bed 104 (or vice versa) in order to apply a press force to the lens material 140.

In certain example embodiments, the upper press bed 102 and upper shim 130 are positioned at an angle with respect to the lower press bed 104 and lower shim 110 when in the open position. In such an embodiment, the press 100 is a part of a pivoting press system in which the upper press bed 102 travels at an angle to meet the lower press bed 104 via the upper shim 130 and lower shim 110 such that the upper shim 130 and lower shim 110 become aligned with each other when the press is in the closed position, as illustrated in FIG. 3. In certain example embodiments, the press 100 is a part of a mechanical press system, a hydraulic press system, or any other type of press system suitable for the purposes of the present disclosure.

In certain example embodiments, the upper and lower heat plates 122, 108, further include a temperature control system 121. The temperature control system 121 is used to provide heat and/or cooling to the heat plates 122, 108 and the shims 130, 110. In an example embodiment, in each of the upper and lower heat plates 122, 108, the temperature control system 121 includes an inlet 124 and an outlet 126 connected by a channel 128 through which temperature controlled fluid can travel, thereby, for example, providing heat to the upper and lower heat plates 122, 108 and the upper and lower shims 130, 110 for softening or melting the lens material 140 to a certain degree. In certain example embodiments, the temperature control system 121 includes a heating channel for heating the upper and lower shims 130, 110 to soften or melt the lens material 140, and a cooling channel for cooling the upper and lower shims 130, 110 for solidifying or hardening the patterned lens 400. In certain example embodiments, the temperature control system 121 includes electric heat rods or other appropriate heating systems. In certain example embodiments, one or more types of temperature control systems 121 are used in combination.

At least one of the upper and lower shims 130, 110 includes patterned protrusions and/or recesses on its surface for stamping a corresponding pattern onto the lens material 140 in order to form the patterned lens 400. In an example embodiment, the upper and lower shims 130, 110 are fabricated from a heat conductive material such as metal such that heat is conducted from the upper and lower heat plates 122, 108 to the lens material 140. In certain example embodiments, the upper and lower shims 130, 110 are removably coupled to the upper and lower heat plates 122, 108, respectively. Thus, upper and lower shims 130, 110 of different patterns may be interchangeably used with the same press 100 to form patterned lenses 400 having different patterns. In certain example embodiments, the lens material 140 is a previously fabricated acrylic material. In certain example embodiments, the lens material 140 is a sheet of acrylic material previously fabricated in a desired thickness, length, and width or subsequently cut into the desired dimensions. In certain other example embodiments, the lens material 140 is another appropriate material for fabricating a lens, such as a polycarbonate material.

FIGS. 1 and 2 illustrate first and second steps in the process of forming a light lens through hot stamping. Specifically, the press 100 is put in the open position, in which the upper shim 130 is separated from the lower shim 110, and the lens material 140 is placed on the lower shim 110. FIG. 3 illustrates a subsequent step in which the press 100 is closed such that the upper shim 130 is in contact with the lens material 140 opposite the lower shim 110, which is also in contact with the lens material 140. In certain example embodiments, pressure is added to the upper and/or lower press beds 102, 104 in the direction of the lens material 140. In certain example embodiments, the temperature control system 121 provides heat to the upper and/or lower shims 130, 120. In certain example embodiments, the upper and/or lower shims 130, 110 are preheated before the lens material 140 is placed in the press 100. Thus, given an appropriate amount of pressure, heat, and time, the lens material 140 becomes malleable enough to be deformed. The surfaces of the lens material 140 then take on a pattern corresponding to that of the upper and lower shims 130, 110, respectively. The lens material is then cooled and allowed to solidify, forming the patterned lens 400. In certain example embodiments, the temperature control system 121 provides cooling to the upper and lower shims 130, 110 to aid the cooling and solidification of the lens material 140 or patterned lens 400. In a subsequent step, and as illustrated in FIG. 4, the press 100 is then put in the open position, and the patterned lens 400 is removed. The patterned lens 400 now includes one or more patterned surfaces that direct light in a desired pattern.

Although the inventions are described with reference to example embodiments, it should be appreciated by those skilled in the art that various modifications are well within the scope of the invention. From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the example embodiments, equivalents of the elements shown therein will suggest themselves to those skilled in the art, and ways of constructing other embodiments of the present invention will suggest themselves to practitioners of the art. Therefore, the scope of the present invention is not limited herein.

What is claimed is:

1. A method comprising the steps of:
receiving a lens material into a heat press, wherein the heat press comprises:
a first press bed;
a first heat plate coupled to the first press bed, the first heat plate comprising a temperature control system;
a first shim comprising a first side and a second side, the first side coupled to the first heat plate opposite the first press bed and the second side having a first pattern, wherein heat is conductive between the first heat plate and the first shim; and
a second press bed aligned with respect to the first shim, wherein the lens material is disposed between the second press bed and the first shim;
applying pressure to the lens material while disposed between the first shim and the second press bed;
heating the lens material via heat provided to the first shim from the temperature control system of the first heat plate; and
transferring a pattern corresponding to the first pattern of the first shim to the lens material, thereby forming a patterned lens.

2. The method of claim 1, further comprising:
cooling the lens material via coolant provided by the temperature control system.

3. The method of claim 1, wherein the heat press further comprises a second shim disposed between the lens material and the second press bed.

4. The method of claim 1, wherein the heat press comprises a second heat plate disposed on the second press bed and configured to provide heat to the lens material.

5. The method of claim 1, wherein the temperature control system comprises a heating system and a cooling system.

6. The method of claim 5, wherein the heating system comprises a heating channel through which a heating fluid can travel, and wherein the cooling system comprises a cooling channel through which a cooling fluid can travel.

7. The method of claim 5, wherein the heating system comprises one or more heating rods.

8. A system comprising
a first press bed;
a first heat plate coupled to the first press bed, the first heat plate comprising a first temperature control system;
a first shim comprising a first side and a second side, the first side coupled to the first heat plate opposite the first press bed and the second side having a first lens pattern, wherein heat is conductive between the first heat plate and the first shim; and
a second press bed aligned with respect to the first shim, wherein a lens material is to be placed between the second press bed and the first shim.

9. The system of claim 8, further comprising:
a second heat plate coupled to the second press bed; and
a second shim comprising an upper side and a lower side side, the lower side of the second shim coupled to the second heat plate opposite the second press bed.

10. The system of claim 8, wherein the first shim and the first heat plate are integrally formed.

11. The system of claim 8, wherein the first shim is removably coupled to the first heat plate.

12. The system of claim 8, wherein the temperature control system comprises a heating system and a cooling system.

13. The system of claim 8, wherein the first press bed is moveable towards the second press bed along a defined path and distance.

14. The system of claim 9, wherein the upper side of the second shim has a second lens pattern.

15. The system of claim 12, wherein the cooling system comprises a cooling channel through which a cooling fluid can travel.

16. The system of claim 12, wherein the heating system comprises a heating channel through which a heating fluid can travel.

17. A method comprising:
receiving a lens material into a heat press, the heat press comprising a patterned shim;
applying pressure to the lens material with the heat press, wherein the patterned shim is in contact with and pressed against the lens material;
heating the lens material with the heat press; and
transferring a pattern corresponding to the patterned shim to the lens material, thereby forming a patterned lens.

18. The method of claim 17, further comprising:
cooling the lens material with the heat press.

19. The method of claim 18, wherein the heat press comprises a temperature control system configured to heat and cool the lens material.

20. The method of claim 19, wherein the temperature control system comprises a heating channel through which a heating fluid can travel and a cooling channel through which a cooling fluid can travel.
